(19) United States
(12) Patent Application Publication
(10) Pub. No.: US 2026/0037502 A1
(43) Pub. Date: Feb. 5, 2026

(54) NATURAL LANGUAGE PROCESSING FOR METADATA QUERY

(71) Applicant: Box, Inc., Redwood City, CA (US)

(72) Inventors: Chandra Cherukuri, San Mateo, CA (US); Sesh Jalagam, Union City, CA (US); Max Iashin, San Jose, CA (US); Arunabh Shrivastava, Redwood City, CA (US); Matt Riley, Round Rock, TX (US)

(73) Assignee: Box, Inc., Redwood City, CA (US)

(21) Appl. No.: 18/791,310

(22) Filed: Jul. 31, 2024

(51) Int. Cl. G06F 16/242; G06F 16/248; G06F 40/174; G06F 40/186; G06F 40/58

(52) U.S. Cl. CPC G06F 16/243; G06F 16/248; G06F 40/174; G06F 40/186; G06F 40/58

(57) ABSTRACT

Disclosed is an improved approach to implement natural language processing for metadata queries. The query may be applied against metadata for content stored in a cloud-based content management system.

### CROSS-REFERENCE TO RELATED APPLICATION(S)

The present application is related to U.S. application Ser. No. 18/746,466, which is hereby incorporated by reference in its entirety.

### BACKGROUND

Cloud-based content management services and systems have impacted the way personal and enterprise computer-readable content objects (e.g., files, documents, spreadsheets, images, programming code files, etc.) are stored, and have also impacted the way such personal and enterprise content objects are shared and managed. Content management systems provide the ability to securely share large volumes of content objects among trusted users (e.g., collaborators) on a variety of user devices such as mobile phones, tablets, laptop computers, desktop computers, and/or other devices. Modern content management systems host many thousands or, in some cases, millions of content objects.

It is desirable to provide a mechanism to allow users to search and query within the content stored in a cloud-based content management system. This is beneficial to users, since users often need to search for content objects that include the specific content sought by a user. For example, a user in a sales department may wish to query for all contract documents stored by that department in the cloud storage system having a date range from 2023-2024 which include a sales price greater than $10,000. As another example, a user in the legal department of a company may wish to query for all non-disclosure agreements signed in 2021 which pertain to an employee located in the state of California.

However, many query systems require the user to implement a query using a specialized query language. Such query languages (such as the Structured Query Language or SQL) are essentially in the form of programming code having a required syntax and format which must be strictly adhered to in order for the query to be properly processed. The problem is that many ordinary users that may seek to query for information in a cloud-based content management system may not have enough knowledge or experience to be able to program queries in these types of languages.

Therefore, there is a need for an improved to implement queries in a cloud-based environment that addresses the problems identified above.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

Embodiments of the invention provide an improved approach to implement natural language processing for metadata queries, e.g., for content stored in a cloud-based content management system.

Further details of aspects, objectives and advantages of the technological embodiments are described herein, and in the figures and claims.

### BRIEF DESCRIPTION OF THE DRAWINGS

The drawings described below are for illustration purposes only. The drawings are not intended to limit the scope of the present disclosure.

FIG. 1A shows a high level architecture of a system for implementing natural language processing for queries against metadata within a content management system according to some embodiments of the invention.

FIG. 1B shows a high level flowchart of some embodiments of the invention.

FIG. 2 provides an illustration of an example content management system to which queries may be executed against.

FIG. 3 shows a detailed architecture for implementing NLP-based queries according to some embodiments of the invention.

FIG. 4 shows a flowchart of an approach to perform the translation of the natural language query into a query in a specific query language format such as MQL.

FIGS. 5A and 5B provide an illustration of an implementation of a metadata query platform according to some embodiments of the invention.

FIG. 5C shows a detailed flowchart to implement some embodiments of the invention.

FIG. 6A shows an example metadata template.

FIG. 6B shows an example user interface for creating/viewing an object created according to a metadata template.

FIG. 6C shows an example metadata instance that may be created for the document shown in FIG. 6B.

FIG. 6D shows a metadata template used in conjunction with the metadata instance to correspond to an associated query data row in the query store.

FIGS. 6E-1, 6E-2, and 6E-3 show an example of a meta schema.

FIG. 6F shows an example of a query data row that is produced by the combination of the metadata instance and the meta schema.

FIGS. 7, 8, and 9 provide an illustration of the process to process a metadata query according to some embodiments of the invention.

FIG. 10 shows a flowchart of an approach to perform metadata extraction according to some embodiments of the invention.

FIG. 11 shows a flowchart of an approach to implement the output processor according to some embodiments of the invention.

FIG. 12A and FIG. 12B present block diagrams of computer system architectures having components suitable for implementing embodiments of the present disclosure and/or for use in the herein-described environments.

### DETAILED DESCRIPTION

Disclosed herein are techniques for implementing an improved query mechanism to query metadata for content stored in a cloud-based content management system. With embodiments of the invention, natural language processing may be employed to implement queries against metadata within a content management system.

Some of the terms used in this description are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

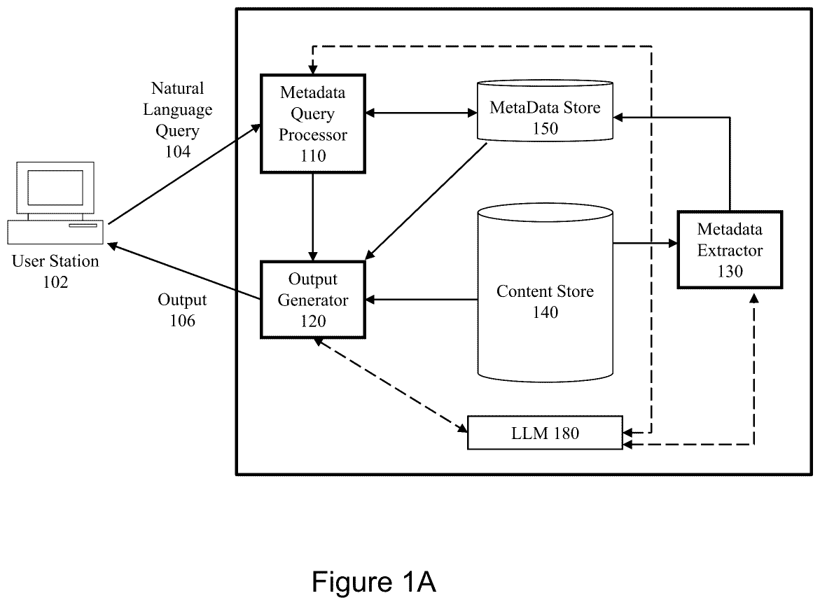

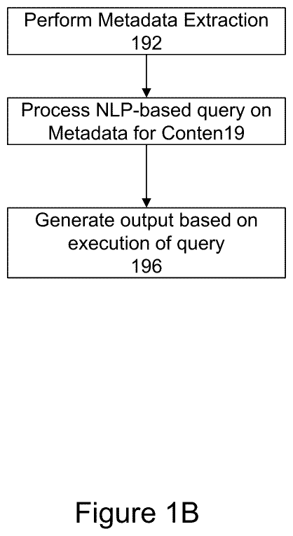

FIG. 1A shows a high level architecture of a system for implementing natural language processing for queries against metadata within a content management system according to some embodiments of the invention.

The system includes a cloud service/platform, collaboration and/or cloud storage service with capabilities that facilitate collaboration among users as well as enable utilization of content in the workspace. The system therefore includes a host environment that in some embodiments is embodied as a cloud-based and/or SaaS-based (software as a service) storage management architecture. This means that host environment is capable of servicing storage functionality as a service on a hosted platform, such that each customer that needs the service does not need to individually install and configure the service components on the customer's own network. The host environment is capable of providing storage services to multiple separate customers, and can be scaled to service any number of customers. The system may include a content manager that is used to manage data content stored on one or more content storage devices. The content storage devices comprise any combination of hardware and software that allows for ready access to the data that is located at the content storage device. For example, the content storage device could be implemented as computer memory operatively managed by an operating system, hard disk drives, solid state drives, networked attached storage, storage area networks, cloud-based storage, or any other type of storage architecture that is capable of storing data. The data in the content storage device can be implemented as any type of data objects and/or files.

The system may include one or more users at one or more user stations 102 that use the system across a network to operate and interact with the system. The user station 102 comprises any type of computing station that may be used to operate or interface with the system. Examples of such user stations include, for example, workstations, personal computers, mobile devices, or remote computing terminals. The user station comprises a display device, such as a display monitor, for displaying a user interface to users at the user station. The user station also comprises one or more input devices for the user to provide operational control over the activities of the system, such as a mouse or keyboard to manipulate a pointing object in a graphical user interface to generate user inputs.

In some embodiments, the user at the user station 102 will provide a natural language query 104 to query for content within the system. A natural language query (NLQ) permits the user to ask questions using everyday language, rather than requiring the user to write the query in a specialized query language. For example, the user may pose questions such as “identify all contracts greater than $100 from 2023” or “show me the trend for contract prices over the last 5 years”.

With embodiments of the invention, the NLQ is used to query within metadata within the system to answer the user's questions. To explain, consider that a document, such as a form or contract, may have defined fields or types of information within that document. For example, such forms or contract may include portions of the document that identify defined information such as dates, names, titles, prices, etc. By capturing this information as metadata about the document, this permits a metadata-based query to be processed against these specific fields. The metadata query can specifically look for documents that match a given date, name, price, etc. by querying the metadata for the documents to identify documents having data metadata, name metadata, or price metadata that matches the appropriate metadata predicate in the query.

The original content is stored within a content store 140. A metadata extractor 130 may be employed to identify and extract the metadata from the stored content in the content store 140. The extracted metadata is then maintained in a metadata store 150.

When a natural language query is received from a user, that natural language query is received and processed by a metadata query processor 110. The metadata query processor 110 will take the natural language query, and will translate that query into a form that can then be used to query against the metadata store. For example, the metadata query processor 110 may translate the natural language query into a specialized query language such as SQL or the metadata query language (MQL). The query in the query language is then executed against the metadata store 150 to identify a result set.

An output generator 120 is used to format the result set into a useable form for the user. As discussed in more detail below, it is possible that the output provided to the user may be selected from among multiple different output formats. Therefore, an output generator 120 is used to provide the output 106 in an appropriate format to be sent to the user at the user station 102.

Various tools may be used at different parts of the query processing within the system. For example, such as machine learning tools or a Large Language Models (“LLMs”, and which may also be referred to herein as “generative AIs”). The LLM 180 can be used in conjunction with the natural language processing techniques described above to perform query processing upon the content metadata. Specifically, the LLM can be to translate the natural language query into a query language format, to extract metadata from the underlying content in the content store 140, and/or to produce a desired output by the output generator 120.

FIG. 1B shows a high level flowchart of some embodiments of the invention. At 192, metadata extraction is performed to extract metadata from content stored within the system. The general idea is that instead of working with a “flat” or “flattened” document, metadata is identified for a document to impose some sort of organizational or hierarchal structure to the document content. With a flat document, such hierarchy or organizational structure either does not exist or has been removed from the documents, which makes terms or words within the documents individually searchable at the same “root” level of the search semantics. However, the problem with this approach is that the flattening of the document also removes the ability to search based upon those hierarchical aspects of the data. For example, consider if a document includes a field such as “date” with a value for that field as “2023”. Flattening the document will remove the concept of such fields. While searching may still occur for the specific value “2023” in the flattened document, the flattened document will no longer be able to support a query that searches using the date field. By extracting metadata from a document, this permits these types of fields to be queryable using a predicate appropriate for the respective fields. It is noted that this extraction approach allows a document that is not already formatted to currently include these specialized types of information as existing metadata (that are being queried) to nonetheless be processed to identify such fields within the document and extracted as metadata. Thus, any document can be processed to identify and extract queryable metadata from that document. This means that multiple different types of unstructured or semi-structured documents may all be processed to extract a common set of metadata from those different types of documents, and the same metadata query used to query (even at the same time) against these documents (the metadata for these documents). This is quite different from alternate approaches that only allow such queries at the same time against commonly-structured or common-schema documents.

At 194, a NLP-based query is processed against metadata in the system. This action is performed by intaking a NLP-based query, and then translating that NLP-based query into the appropriate query language. For a query against metadata, the NLP-based query is translated, for example, into the MQL format. That translated query is then executed against a set of metadata to provide a result set.

At 196, the output presented to the user is generated based upon the result from executing the query. The output that is generated will be based upon the specific question that is posed by the user, and the exact type of output that is sought by the user. The output format may be particularly identified by the user in the question, or may be inferred by the system.

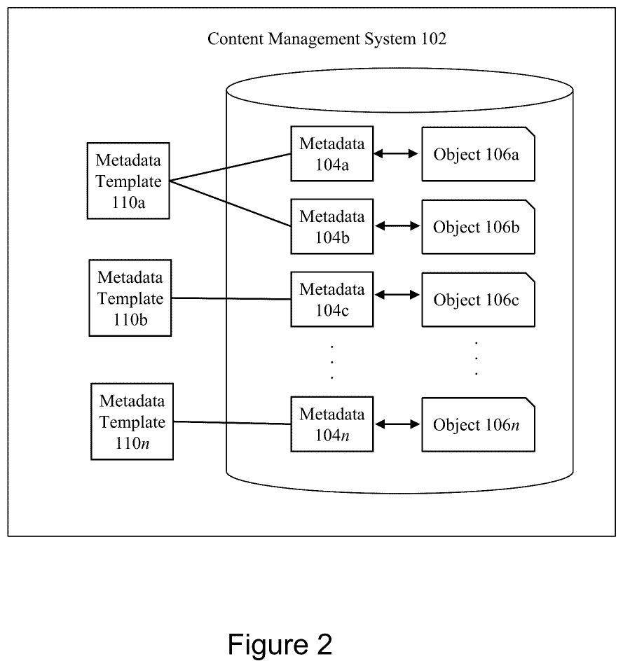

FIG. 2 provides an illustration of an example content management system 102 to which queries may be executed against. Content management system 102 may include numerous content objects 106a-n, where each object corresponds to an item of content that is stored within the system. These content objects may, for example, corresponds to a file in a file system or to an object in an object-based system. For purposed of explanation, any type of content stored within a content management system may be collectively referred to as either an “object” or “file” or “folder” throughout this document, without limitation to any specific characteristic of either a file or an object or a folder.

Each content object may be associated with a set of metadata, such as metadata 104a-n. Metadata defines and stores custom information associated with the files/objects in the system. The metadata values can be set either within a content management application or programmatically via an API (application programming interface).

One way to implement and/or use metadata is through the concept of metadata templates 110a-110n. A metadata template is a logical grouping of metadata attributes that help classify content. For example, a marketing team at a retail organization may have a Brand Asset template that defines a piece of content in more detail. This Brand Asset template may have attributes like “Line”, “Category”, “Height (px)”, “Width (px)”, or “Marketing Approved”.

Metadata templates are useful for numerous reasons. One use case is to enforce uniformity across an enterprise's metadata. Another advantage of such templates is to reduce errors and accelerate data entry by employees or team members. With respect to embodiments of the current invention, the metadata template provides advantages to permit advanced searches with content associated with the metadata template.

A metadata template 110a may be defined for a particular use scenario, e.g., for a specific document used by a certain team within an organization. For each instance of an object 106a or 106b that corresponds to this template 110a, each such object will have a set of metadata that is populated for that object according to the metadata template, e.g., where metadata 104a is populated according to template 110a for object 106a. In this way, most or all the objects stored within the content management system 102 will be associated with metadata that corresponds to those stored objects.

As an illustrative use case, consider an application for managing and processing electronic signatures. Metadata templates can be used to automatically add the same fields and formatting to requests for signature. The advantage is that with such templates, the user does not need to repetitively add the same fields to each request every time a new document is sent for signature. Template fields may be provided to allow selection of specific fields for a given template. For example, the following are possible fields to use for an e-signature application: (a) Signature Stamp; (b) Initials; (c) Date signed; (d) Name; (e) Company′ (f) Email; (g) Title; (h) Text input; (i) Checkbox field; (j) Attachment; (k) Radio button′ (l) Dropdown menu.

Metadata searching can be performed based upon the metadata templates. In particular, to optimize metadata searching, one can implement a metadata query that searches for objects based on metadata templates and attributes.

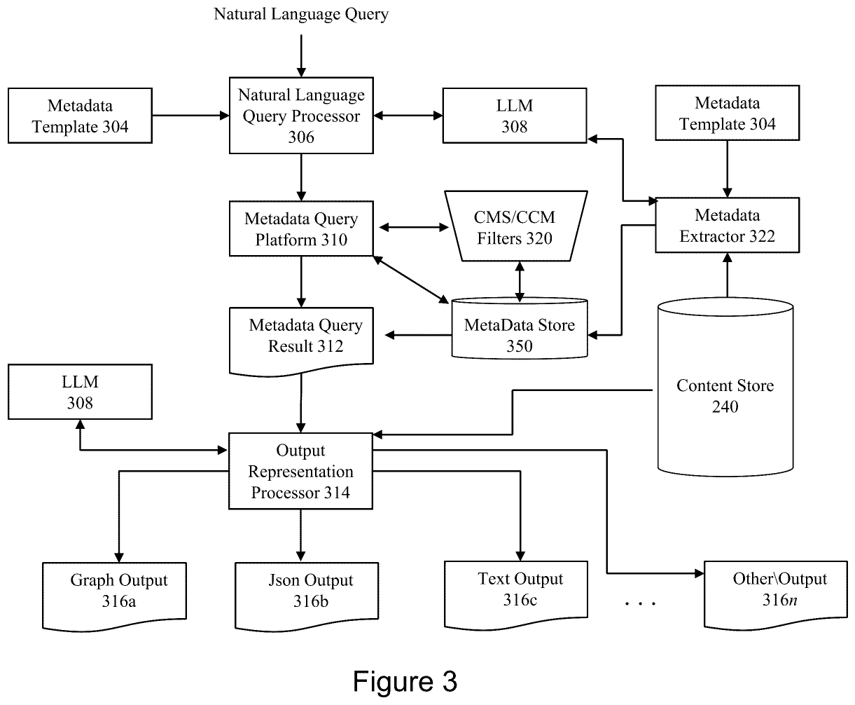

FIG. 3 shows a detailed architecture for implementing NLP-based queries according to some embodiments of the invention. A NLP-based query is received at the natural language query processor 306. The natural language query processor 306 will access one or more metadata templates 304 and will utilize a LLM 308 to generate a query language based query. That query language based query will be sent to a metadata query platform 310 to process the query.

The metadata query platform 310 executes the query against a metadata store 350. The metadata store is populated by a metadata extractor 322. The metadata extractor 322 accesses one or more metadata templates 304 to determine how to extract metadata from the content store 240. The LLM 308 may be employed to perform the metadata extraction.

The metadata query platform 310 will execute the query to generate query results 312. The query results are sent to an output representation processor 314 to determine the specific output format to deliver to the user. For example, the output representation processor 314 may provide a graph output 316a, json output 316b, text output 316c, or any other suitable form of output 316n. The LLM 308 may be employed to help generate the appropriate output format.

The CMS/CCM filter 320 (“content management system” or “cloud content management”) may be used to filter the results and/or query operation with regards to the user. In the CMS/CCM, it is likely that users will only have access to specific items or types of documents to which that user has permission for access. In this situation, it would be efficient to allow some sort of filtering to occur. For example, filtering may be applied by considering the user's access permissions, and performed at query execution time by adjusting the predicate of the query so that the query will produce results that include only documents for which the user has permission to access. The filtering may also be applied post-querying to filter out the result set for permissible documents.

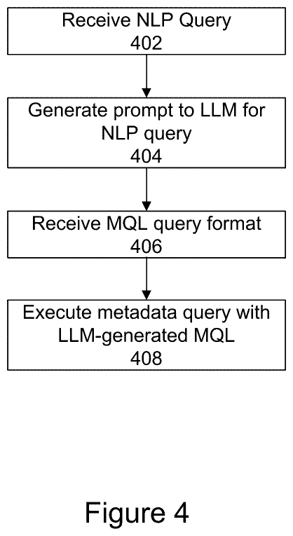

FIG. 4 shows a flowchart of an approach to perform the translation of the natural language query into a query in a specific query language format such as MQL. At 402, a NLP-based query is received.

At 404, a prompt is generated for a LLM to generate the MQL-based query. In some embodiment, the prompt is based on getting the schema data for the metadata (e.g., using the schema template), which identify the data fields and data formats. These items of schema data are then packaged with the natural language query as a prompt for the LLM to generate the query-language format. For specialized query languages that are not in common usage, the prompt may include additional information about the syntax and structure of the query language.

It is noted that there may be a choice of multiple templates that may be used in this step. One approach is to request the user to identify the correct template. Another solution is to infer the correct template based upon the current context, e.g., the identity of the user and the current workload being operated upon by the user, as well as possibly past behavior and documents to which the user has access to.

At 406, the prompt is fed to the LLM, and a MQL-based query is thereafter received from the LLM. At 408, the MQL-based query is executed against the metadata store to obtain a result set.

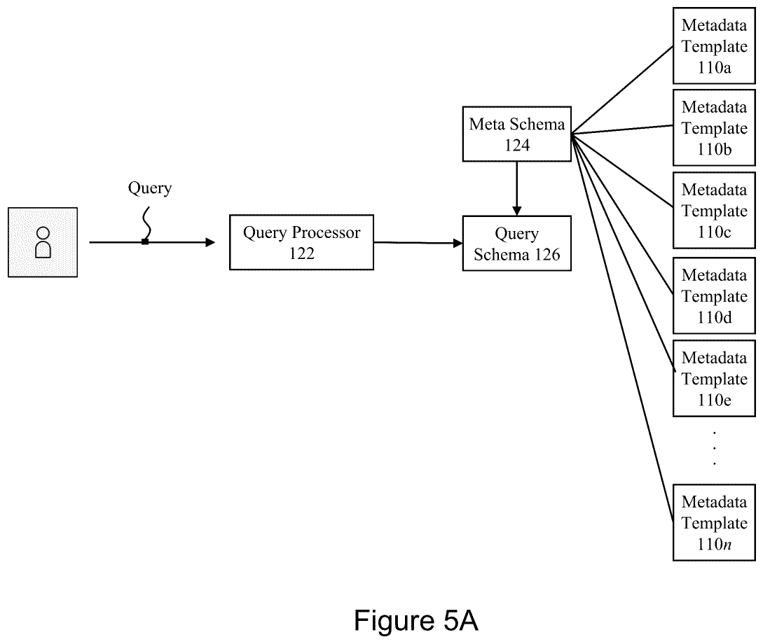

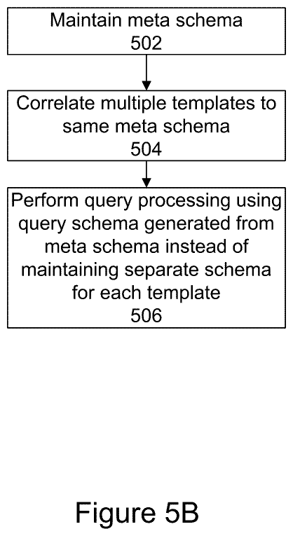

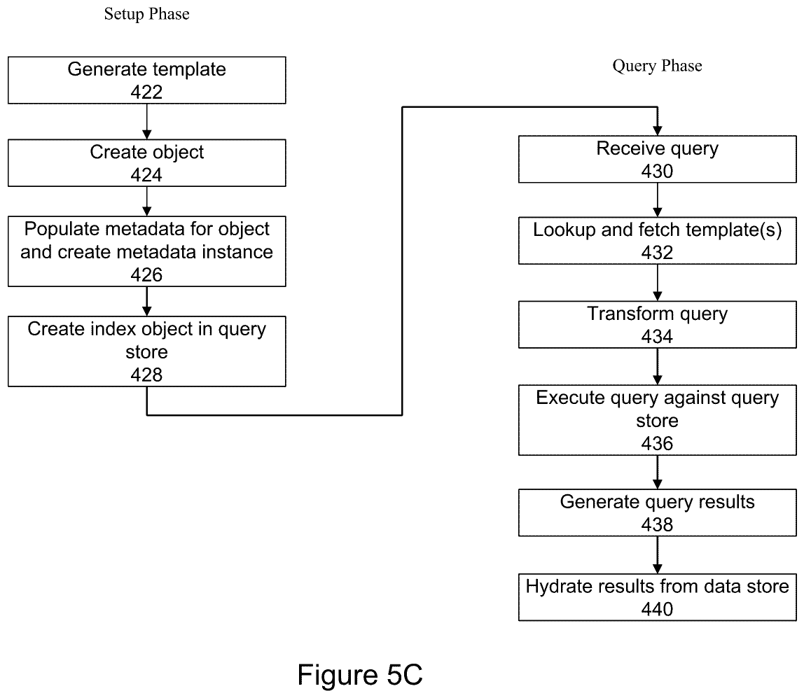

FIGS. 5A and 5B provide an illustration of an implementation of a metadata query platform according to some embodiments of the invention. FIG. 5A shows how a meta schema is employed that is associated with multiple metadata templates, rather than requiring each template to be associated with its own dedicated schema. When a query is received by the query processor, the meta schema is used to dynamically create a query schema that is specific to the one or more metadata templates being queried. However, instead of persistently maintaining such specific schemas, the query schema 126 can instead be created in real time on an as-needed basis.

FIG. 5B shows a high-level figure of a flowchart to implement some embodiments of the invention. At 502, a meta schema is maintained for the system. The meta schema includes a comprehensive set of fields that is expansive enough to encompass the individual fields that would otherwise exist within any specific schema for a template.

At 504, multiple metadata templates created in the system are correlated to the same meta schema. What this means is that instead of creating a separate schema for each template, the same meta schema is used for those multiple various templates.

During query processing, at 506, a query schema is generated from the meta schema. The query schema essentially forms a parent tree of fields that encompasses the fields in the template being queries. This created a format for allowing a structured metadata query to query against the individual metadata fields that are present in the template being queries.

FIG. 5C shows a detailed flowchart to implement some embodiments of the invention. At step 422, one or more metadata templates are generated within the system. Each of the metadata templates generated at this step correspond to a specific object, file, or document to be created for a given purpose, and will therefore be defined to include certain items of metadata to further the purpose of any corresponding objects to be created.

At 424, one or more objects are created that correspond to a metadata template. This action creates an instance of the metadata template. For example, consider if a metadata template is generated for a sales contract for a company at 422. The metadata template will be defined to include filed for information that would be pertinent to a sales contract, such as a date field, customer name field, and price field. During the course of operating the business that is associated with this metadata template, the business may perform sales operations that result in the creation of a sales contract for each customer that makes a purchase. An instance of an object (sales contract) corresponding to the related metadata template would be created for each sales contract, where multiple sales contracts would therefore result in multiple instances of the sales contract objects being created in the system.

At 426, the objects would be populated with metadata as defined by the metadata template for the objects. For example, if the metadata template defines date, customer name, and price as fields for the object, then each of these items of metadata can be populated for the object.

At 428, an index object would be created in a query store for the object. This action extracts relevant metadata from objects created in the system, and stores them into a queryable storage location. Any suitable approach can be taken to extract and store this metadata information. The system essentially analyzes the set of metadata defined by the metadata template, and search for items within a document that match the metadata defined in the metadata template. For example, if the metadata template defines “sales price” metadata, then the system will search the document to try and find a sales price (e.g., using a text/word search or using machine learning), and will then store that identified value as the sales price metadata for the index entry for that object.

At 430, a metadata query may be received from a user to perform a search of the objects. The metadata query may be implemented using a metadata API that allows the user to programmatically find content on the basis of extracted metadata from the underlying objects. With this approach, the query can use a set of parameters and conditions in a structure similar to a traditional SQL query, and identify matching files and folders along with the corresponding metadata.

At 432, the metadata query is processed to lookup and fetch the one or more metadata templates that correspond to the query. In one embodiment, the query itself will refer to the appropriate metadata template that is being queried. Alternatively, the system can infer the appropriate template(s) that should be fetched to process the query, e.g., based upon analysis of the specific user making the query, the permissions held by the user to access documents corresponding to certain template types in the system, and the parameters/fields set forth in the query.

At 434, the query is transformed into a form that is appropriate for execution against the query store. As discussed in more detail below, both the template and the meta schema are used to create one or more intermediate representations of the query before it is executed against the query store at 436. It is this sequence of actions that correlate to the idea of generating a “query schema”, since the transformation(s) into the various different representations will create a search structure that is appropriate for the specific set of metadata being queried.

At 438, query results would then be generated from execution of the query. In some embodiments, execution of the query would generate results from the query store itself, which produces a list of files that match the metadata query results. The underlying files are actually held in a separate content store. Therefore, at 440, the query results would be hydrated from the content store to produce the files (or appropriate file portions) that are match the metadata query results, and which would be provided to the user in response to the query.

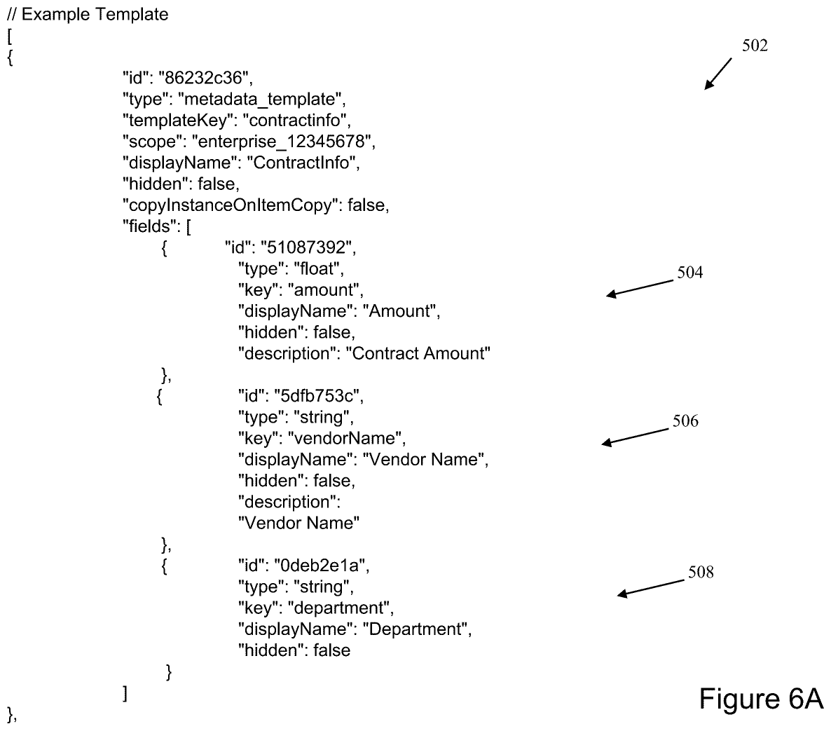

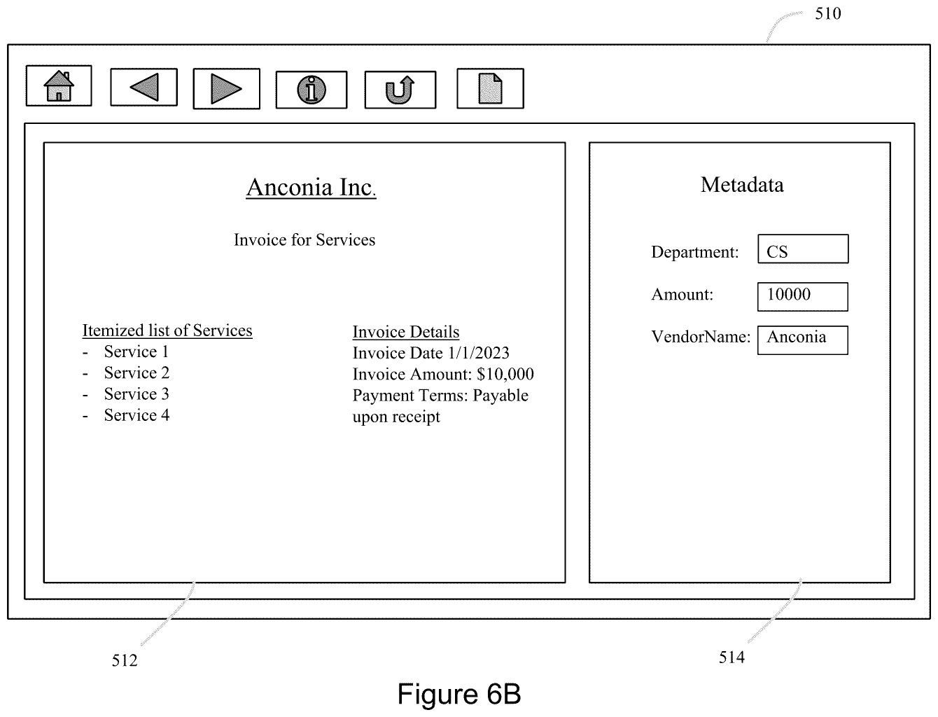

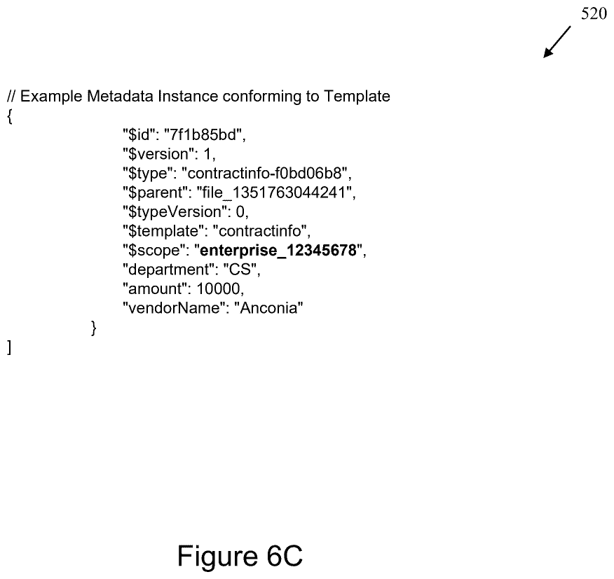

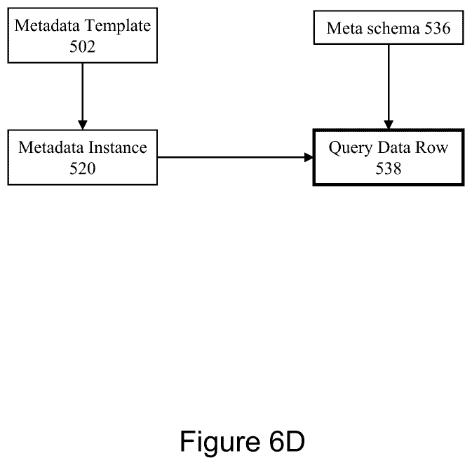

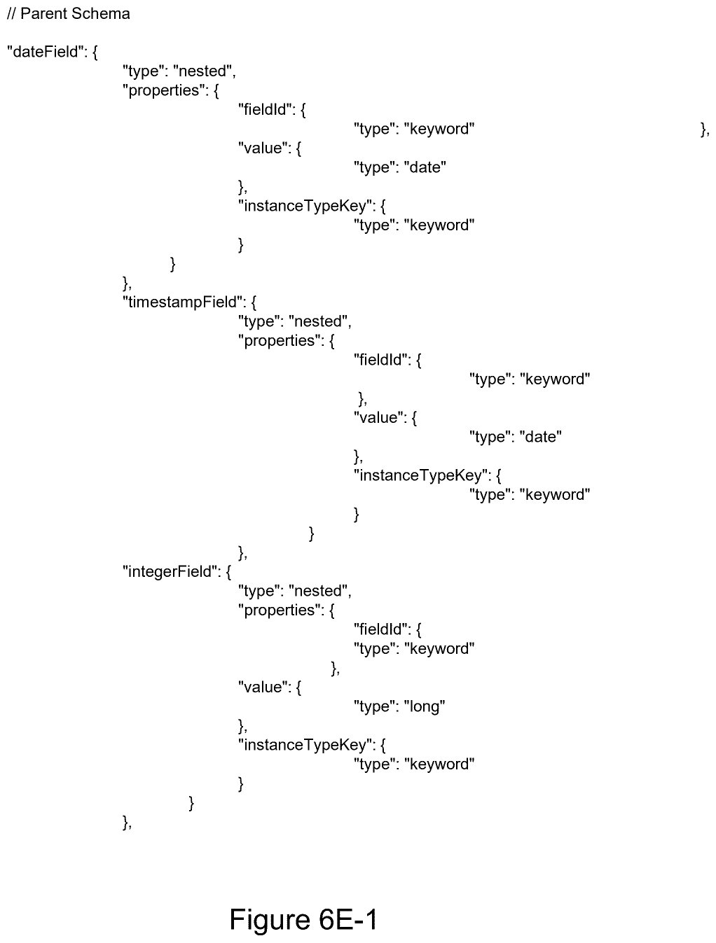

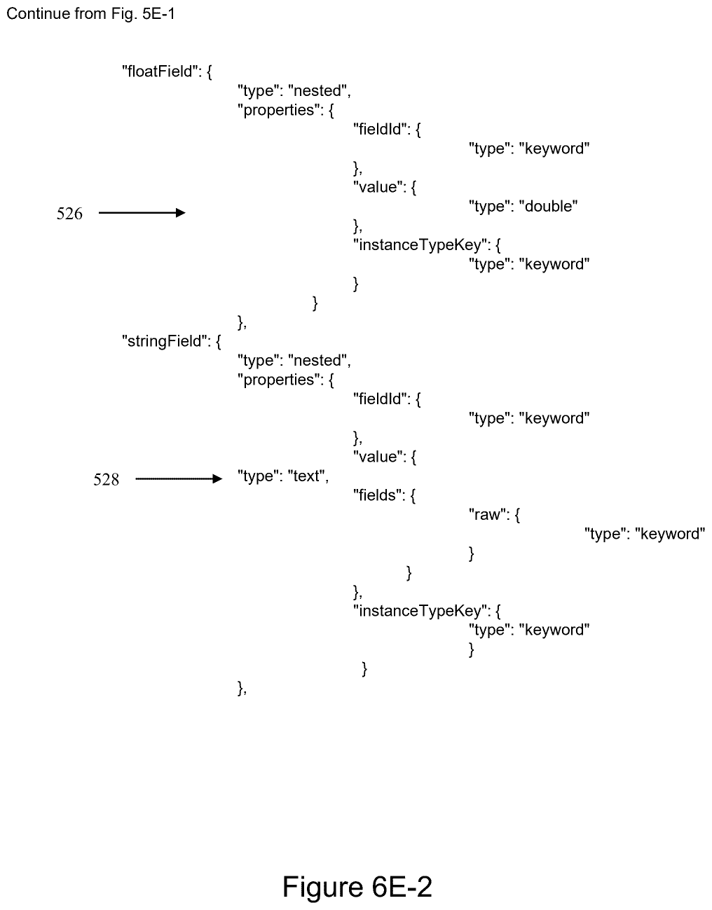

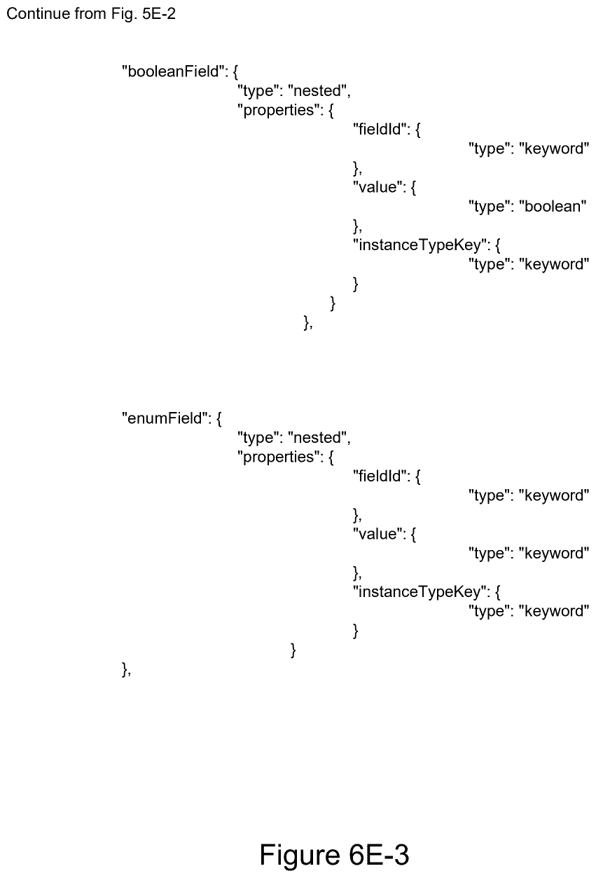

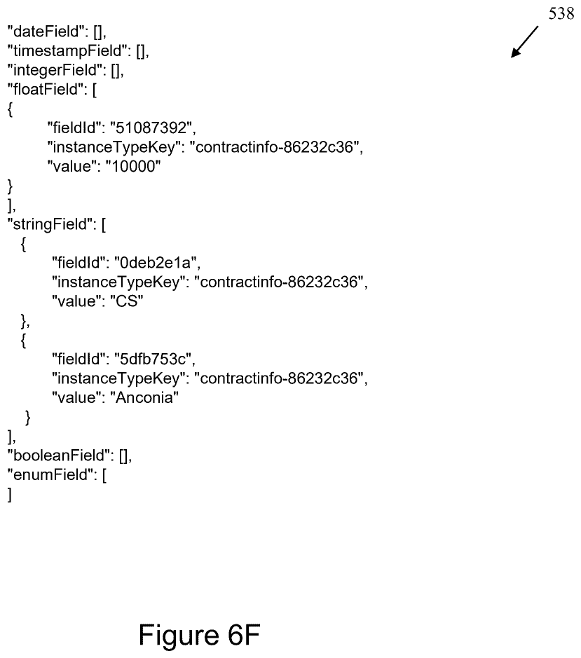

FIGS. 6A-F provide an illustrative example of this process. FIG. 6A shows an example metadata template 502. The metadata template is defined to include one or more fields. In this example, template 502 was likely created for contract-related or invoice-related documents, and hence it includes fields appropriate for such documents. For example, field 504 pertains to metadata for an “amount” field that corresponds to a contract amount, along with parameters associated with this type of field such as a defined type of “float” for these metadata values and identifying its key as “amount”. Field 506 pertains to metadata for a “vendor name”, which is defined to be a type “string”, and having a key “vendorname”. Field 508 pertains to metadata for a “department”, which is defined to be a type “string”, and having a key “department”.

As previously noted, one or more objects may be created according to the metadata template 502. FIG. 6B shows an example user interface 510 for creating/viewing an object created according to a metadata template. Here, portion 512 shows an example document that has been created according to the temple, which is an invoice that has been generated with certain filed values inside the document. Portion 514 of the interface 510 shows the metadata associated with this document. FIG. 6C shows an example metadata instance 520 that may be created for the document shown in FIG. 5B. This metadata instance 520 is populated with the metadata values that were included in the document shown in the previous figure.

The metadata values are extracted for the document and stored within a metadata store. As shown in FIG. 6D, the metadata template 502 is used in conjunction with the metadata instance 520 to correspond to an associated query data row 538 in the query store. The meta schema 536 is also employed to help generate a query data row 538 that is placed into a query store. It is this set of metadata that is maintained for a specific instance, and which is searched upon wen processing user queries.

FIGS. 6E-1, 6E-2, and 6E-3 show an example of a meta schema. It is noted that this meta schema includes portions that correspond to each of the fields that exist within the metadata template 502, and well as the fields within other metadata templates within the system. For example, portion 526 in the meta schema defines a “floatfield” type, which would be associated with the “contract amount” field 504 in template 502. Portion 528 in the meta schema defines a “stringfield” type which would be associated with the “vendor name” field 506 and “department” field 508 in the template 502.

FIG. 6F shows an example of a query data row 538 that is produced by the combination of the metadata instance 520 and the meta schema 536. This query data row 538 includes the appropriate data that will be used in the later query processing actions to identify the specific instance that is associated with this query data row. As will be described later, any incoming user metadata query will be transformed into various intermediate query formats based upon the query predicates and the meta schema, which will be applied to attempt to match the information placed into this query data row 538.

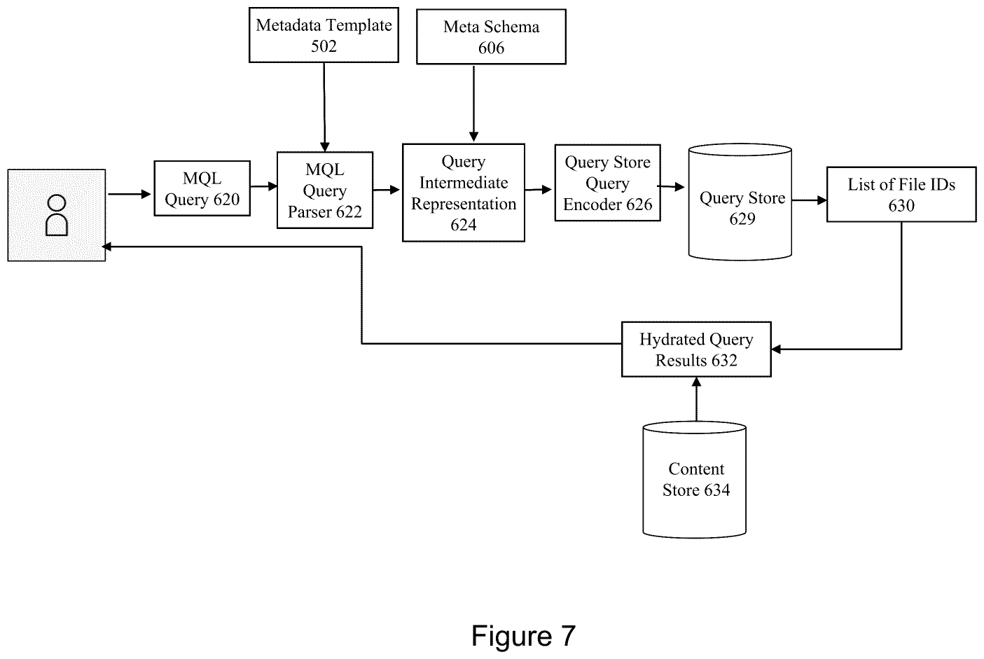

FIGS. 7, 8, and 9 provide an illustration of an approach to process a metadata query according to some embodiments of the invention. A user may issue a metadata query 620 to query against the metadata for objects in the system. For example, a user may issue the query in the MQL format. The syntax and format of a MQL query is similar to that of a SQL database. For example, the following is an example metadata query for all files and folders that match a contract metadata template with a contract value of over $100 the following metadata query could be created:

```
{
  “from”: “foo_enterprise.contracttemplate”,
  “query”: “amount >= :value”;
  “query_params”: {
    “value”: 100
  },
  “fields”:{
    “name”,
    “metadata.foo_enterprise.contracttemplate.amount”
    },
}
```

The “from” value represents the scope and templateKey of the metadata template, and the ancestor_folder_id represents the folder ID to search within, including its subfolders. This query is presented against a specific template (“foo_enterprise.contracttemplate”), and seeks to query for contract(s) according to this template having a metadata for “amount” that is greater than or equal to “100”.

Normally, the metadata query will only return the base-representation of a file or folder, which includes their id, type, and etag values. To request any additional data the fields parameter can be used to query any additional fields, as well as any metadata associated to the item. For example: (a) created_by will add the details of the user who created the item to the response; (b) metadata.<scope>.<templateKey> will return the base-representation of the metadata instance identified by the scope and templateKey; and (c) metadata.<scope>.<templateKey>.<field> will return all fields in the base-representation of the metadata instance identified by the scope and templateKey plus the field specified by the field name. Multiple fields for the same scope and templateKey can be defined. The query parameter represents the SQL-like query to perform on the selected metadata instance. This parameter is optional, and without this parameter the query would return all files and folders for this template. Every left hand field name, like amount, needs to match the key of a field on the associated metadata template. In other words, you can only search for fields that are actually present on the associated metadata instance. Any other field name will result in the error returning an error. To make it less complicated to embed dynamic values into the query string, an argument can be defined using a colon syntax, like :value. Each argument that is specified like this needs a subsequent value with that key in the query_params object. The metadata query may also support any number of logical operators, such as AND, OR, NOT, LIKE, etc. Various comparison operators may also be supported, such as =, >, <, >=, <=, etc. Pattern matching may be implemented using these operators, e.g., to match a string to a pattern or a number type to a numeric value.

The MQL query will be received and parsed by an MQL parser 622. The MQL parser 622 is responsible for analyzing and interpreting the keywords and parameters that are included within the MQL parser. The predicates within the MQL predicate will be identified using the parser 622. For example, assume that predicates 702 correspond to the predicates that were identified by a parser for an MQL query that was received for the metadata template 502 discussed above.

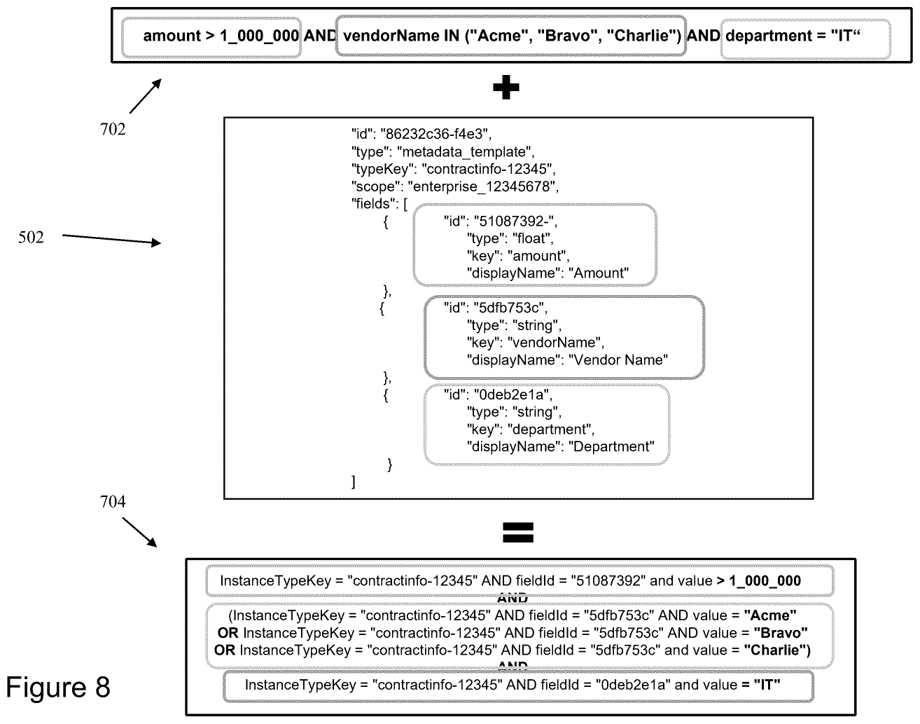

An intermediate query representation will be generated from the parsed MQL query. In particular, as shown in FIG. 8, the query predicates 702 will be analyzed in combination with the metadata template 502 to form an intermediate query representation 704. The intermediate query representation 704 corresponds to a parsed tree representation based upon the specific template 502 being queries. Here, it can be seen that the intermediate query representation 704 includes, for example, information about the typekeys and field IDs for the specific predicates identified from the query.

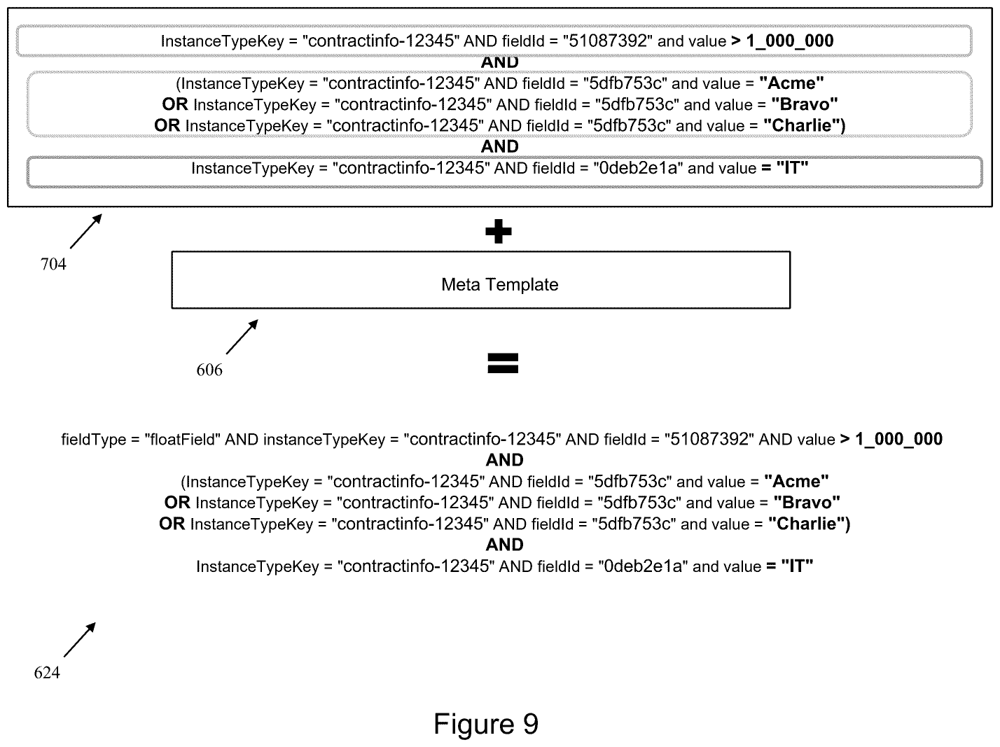

As illustrated in FIG. 9, the intermediate query representation 704 is then analyzed in combination with the meta schema 606 to form another intermediate representation 624. This intermediate representation 624 will now include additional information that is obtained from reviewing the meta schema. For example, routing information is included in the intermediate representation 624 from the meta schema. As shown in the figures, the additional information included in the intermediate representation 624 may correspond to, for example, fieldtype and instancetypekey information.

Next, as shown in FIG. 7, the intermediate representation 624 may be sent to a query store query encoder 626 to generate a query in a format that is suitable to be executed against the query store. This action is highly dependent upon the specific type of query store and query processor that is selected at this stage. For example, assume that an implementation of the invention uses elastic search to process the metadata query. In this example scenario, the query store query encoder 626 would generate a final query in the EQL query syntax from the intermediate query representation 624, and an elastic search would be performed against the query store 628. However, it is noted that this approach of using elastic search is merely illustrative, and the invention is not limited to only this type of search.

The execution of the metadata query will then generate a set of results that identify the files or folders that match the query terms. In some embodiments, the query will produce a set of file or folder IDs from the search of the query store. However, since the actual files/folders themselves are stored in another location in the content store 634, this means that a hydration step 632 is employed to hydrate the results such that the files/folders are provided to the user.

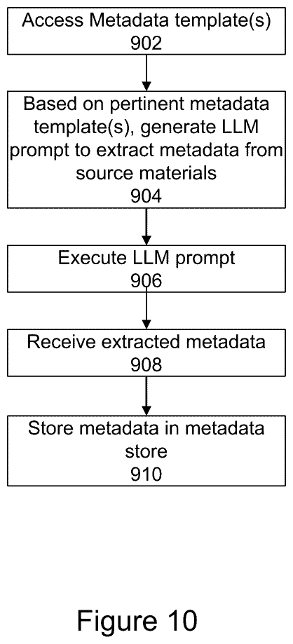

FIG. 10 shows a flowchart of an approach to perform metadata extraction according to some embodiments of the invention. At 902, the appropriate metadata templates are accessed. The templates are reviewed to identify the pertinent data fields and data formats for the fields of interest.

At 904, an appropriate LLM prompt is generated for the metadata extraction. The LLM prompt is based upon selected portions of the source document. Based upon the templates, identification is made of the portions of the source document of interest. This action is performed by using chunk/shingle selection for the pertinent portions of the document. The general idea is that due to context limits for LLMs, it is not possible to send the entirety of the source documents to the LLM. Instead, by analyzing the templates, it is possible to select only the portions of interest that will be sent to the LLM for metadata extraction. The LLM prompt will identify the fields of interest for selection from the chunks that are packaged for delivery to the LLM.

At 906, the LLM prompt is executed by the LLM to produce a result set from the LLM. At 908, the extracted metadata is received from the extraction process. Thereafter, at 910, the extracted metadata is stored into the metadata store.

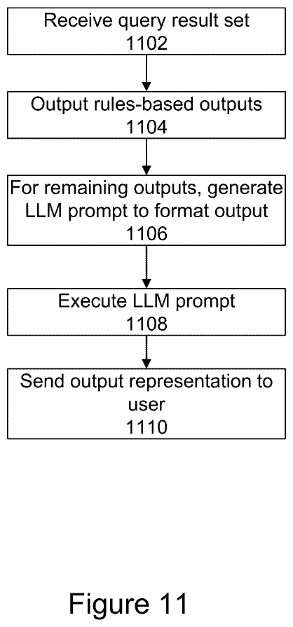

FIG. 11 shows a flowchart of an approach to implement the output processor according to some embodiments of the invention. At 1102, the query result set is received.

At 1104, an initial rules-based processing is performed to generate first types of outputs. These are the types of outputs that do not require the services of an LLM to generate. For example, if the user simply wants a set of files, then a rule will decide at this point to generate a json-based output for the user that provides the requested files identified from the query (e.g., if the user query is: “provide a copy of all contracts signed in 2023 by John Smith”). If the user's questions ask for a simple answer, then a rule may simply generate a text output (e.g., if the user query is: “what is the highest contract amount from 2023”).

However, if a simple rules-based output is not sufficient, then an LLM may be used to help format the appropriate output. Here, at 1106, a prompt may be created to generate the desired output. The prompt may include the user question along with the result set, and the prompt will ask the LLM to generate a suitable output format for the answer. When executed at 1108, the prompt may cause the LLM to generate any suitable and/or possible output format, e.g., a graph, a set of text prose, images, an/or any other type or combination of outputs. At 1110, the generated output is provided to the user.

Therefore, what has been described is an improved approach to implement natural language queries, which are processed to perform metadata queries, e.g., for content stored in a cloud-based content management system.

### System Architecture Overview

### Additional System Architecture Examples

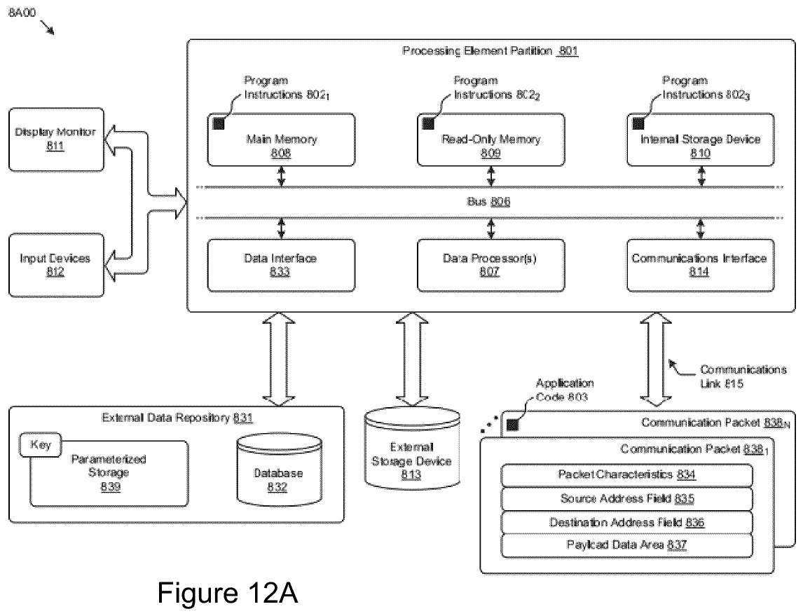

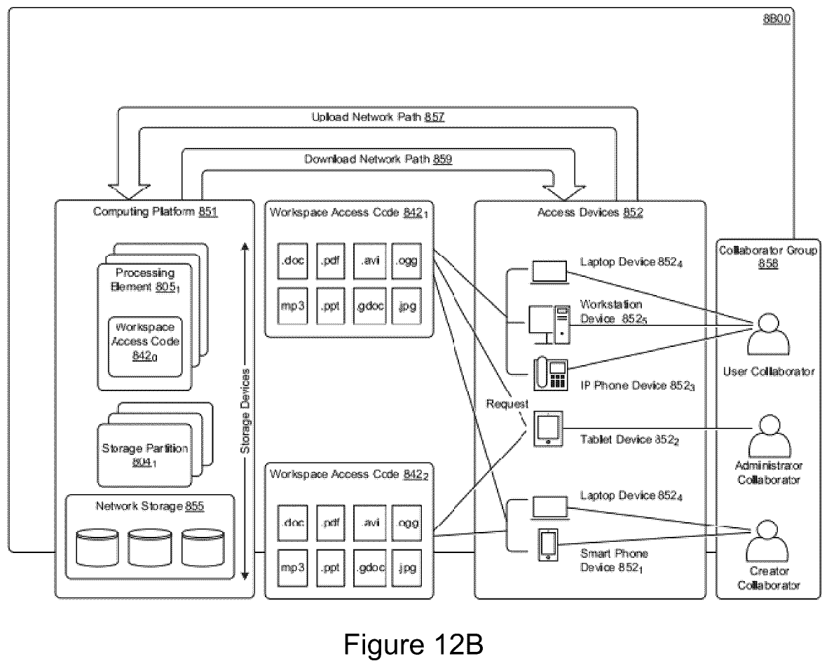

FIG. 12A depicts a block diagram of an instance of a computer system 8A00 suitable for implementing embodiments of the present disclosure. Computer system 8A00 includes a bus 806 or other communication mechanism for communicating information. The bus interconnects subsystems and devices such as a central processing unit (CPU), or a multi-core CPU (e.g., data processor 807), a system memory (e.g., main memory 808, or an area of random access memory (RAM)), a non-volatile storage device or non-volatile storage area (e.g., read-only memory 809), an internal storage device 810 or external storage device 813 (e.g., magnetic or optical), a data interface 833, a communications interface 814 (e.g., PHY, MAC, Ethernet interface, modem, etc.). The aforementioned components are shown within processing element partition 801, however other partitions are possible. Computer system 8A00 further comprises a display 811 (e.g., CRT or LCD), various input devices 812 (e.g., keyboard, cursor control), and an external data repository 831.

According to an embodiment of the disclosure, computer system 8A00 performs specific operations by data processor 807 executing one or more sequences of one or more program instructions contained in a memory. Such instructions (e.g., program instructions 802₁, program instructions 802₂, program instructions 802₃, etc.) can be contained in or can be read into a storage location or memory from any computer readable/usable storage medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 8A00 performs specific networking operations using one or more instances of communications interface 814. Instances of communications interface 814 may comprise one or more networking ports that are configurable (e.g., pertaining to speed, protocol, physical layer characteristics, media access characteristics, etc.) and any particular instance of communications interface 814 or port thereto can be configured differently from any other particular instance. Portions of a communication protocol can be carried out in whole or in part by any instance of communications interface 814, and data (e.g., packets, data structures, bit fields, etc.) can be positioned in storage locations within communications interface 814, or within system memory, and such data can be accessed (e.g., using random access addressing, or using direct memory access DMA, etc.) by devices such as data processor 807.

Communications link 815 can be configured to transmit (e.g., send, receive, signal, etc.) any types of communications packets (e.g., communication packet 838₁, communication packet 838_{N}) comprising any organization of data items. The data items can comprise a payload data area 837, a destination address 836 (e.g., a destination IP address), a source address 835 (e.g., a source IP address), and can include various encodings or formatting of bit fields to populate packet characteristics 834. In some cases, the packet characteristics include a version identifier, a packet or payload length, a traffic class, a flow label, etc. In some cases, payload data area 837 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 807 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 831, which in turn can be formatted into any one or more storage areas, and which can comprise parameterized storage 839 accessible by a key (e.g., filename, table name, block address, offset address, etc.).

Execution of the sequences of instructions to practice certain embodiments of the disclosure are performed by a single instance of a computer system 8A00. According to certain embodiments of the disclosure, two or more instances of computer system 8A00 coupled by a communications link 815 (e.g., LAN, public switched telephone network, or wireless network) may perform the sequence of instructions required to practice embodiments of the disclosure using two or more instances of components of computer system 8A00.

Computer system 8A00 may transmit and receive messages such as data and/or instructions organized into a data structure (e.g., communications packets). The data structure can include program instructions (e.g., application code 803), communicated through communications link 815 and communications interface 814. Received program instructions may be executed by data processor 807 as it is received and/or stored in the shown storage device or in or upon any other non-volatile storage for later execution. Computer system 8A00 may communicate through a data interface 833 to a database 832 on an external data repository 831. Data items in a database can be accessed using a primary key (e.g., a relational database primary key).

Processing element partition 801 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 807. Some embodiments include one or more special-purpose hardware components (e.g., power control, logic, sensors, transducers, etc.). Some embodiments of a module include instructions that are stored in a memory for execution so as to facilitate operational and/or performance characteristics pertaining to form and template detection. A module may include one or more state machines and/or combinational logic used to implement or facilitate the operational and/or performance characteristics pertaining to form and template detection.

Various implementations of database 832 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of form and template detection). Such files, records, or data structures can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to form and template detection, and/or for improving the way data is manipulated when performing computerized operations pertaining to analyzing the features of incoming content objects to match to machine-learned features that define a document template.

FIG. 12B depicts a block diagram of an instance of a cloud-based environment 8B00. Such a cloud-based environment supports access to workspaces through the execution of workspace access code (e.g., workspace access code 842₀, workspace access code 842₁, and workspace access code 842₂). Workspace access code can be executed on any of access devices 852 (e.g., laptop device 852₄, workstation device 852₅, IP phone device 852₃, tablet device 852₂, smart phone device 852₁, etc.), and can be configured to access any type of object. Strictly as examples, such objects can be folders or directories or can be files of any filetype. A group of users can form a collaborator group 858, and a collaborator group can be composed of any types or roles of users. For example, and as shown, a collaborator group can comprise a user collaborator, an administrator collaborator, a creator collaborator, etc. Any user can use any one or more of the access devices, and such access devices can be operated concurrently to provide multiple concurrent sessions and/or other techniques to access workspaces through the workspace access code.

A portion of workspace access code can reside in and be executed on any access device. Any portion of the workspace access code can reside in and be executed on any computing platform 851, including in a middleware setting. As shown, a portion of the workspace access code resides in and can be executed on one or more processing elements (e.g., processing element 805₁). The workspace access code can interface with storage devices such as networked storage 855. Storage of workspaces and/or any constituent files or objects, and/or any other code or scripts or data can be stored in any one or more storage partitions (e.g., storage partition 804₁). In some environments, a processing element includes forms of storage, such as RAM and/or ROM and/or FLASH, and/or other forms of volatile and non-volatile storage.

A stored workspace can be populated via an upload (e.g., an upload from an access device to a processing element over an upload network path 857). A stored workspace can be delivered to a particular user and/or shared with other particular users via a download (e.g., a download from a processing element to an access device over a download network path 859).

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

1. A method, comprising:
maintaining, by a content management system, content in a content store and metadata in a metadata store separate from the content store, the metadata in the metadata store corresponding to the content stored in the content store, both the content and the metadata being managed by a content management system, and wherein the set of metadata is generated by a metadata extractor in the content management system that extracts metadata from the content managed by the content management system;
receiving, at a metadata query processor of the content management system, a natural language query to search within the content managed by the content management system;
converting, by the metadata query processor in the content management system, the natural language query into a metadata query in a metadata query language; and
executing, by the content management system, the metadata query in the metadata query language against the metadata store to generate a metadata query result based on at least the metadata extracted from the content managed by the content management system, wherein the metadata query result identifies a portion of the contents in the content store.

2. The method of claim 1, wherein the metadata query result is processed by an output representation processor to identify an output representation for the metadata query that is presented to a user.

3. The method of claim 2, wherein the output representation for the metadata query that is presented to the user corresponds to at least one of a graph output, a JSON output, or a text output.

4. The method of claim 2, wherein a LLM is used by the output representation processor to select or configure the output representation for the metadata query.

5. The method of claim 1, wherein a filter is applied to restrict display or querying of data that is not permitted to be accessed by a user that submits the natural language query.

6. The method of claim 1, wherein the natural language query is converted into the query in the metadata query language using a LLM.

7. The method of claim 1, further comprising:
creating a document;
populating metadata for the document;
creating a metadata instance for the document; and
creating an index object in the metadata store for the document.

8. The method of claim 1, further comprising:
fetching a template that corresponds to a document;
transforming the query using a meta template; and
executing a transformed query against the metadata store.

9. A computer program product embodied on a computer readable medium, the computer readable medium having stored thereon a sequence of instructions which, when executed by a processor, executes a method comprising:
maintaining, by a content management system, content in a content store and metadata in a metadata store separate from the content store, the metadata in the metadata store corresponding to the content stored in the content store, both the content and the metadata being managed by a content management system, and wherein the set of metadata is generated by a metadata extractor in the content management system that extracts metadata from the content managed by the content management system;
receiving, at a metadata query processor of the content management system, a natural language query to search within the content managed by the content management system;
converting, by the metadata query processor in the content management system, the natural language query into a metadata query in a metadata query language; and
executing, by the content management system, the metadata query in the metadata query language against the metadata store to generate a metadata query result based on at least the metadata extracted from the content managed by the content management system, wherein the metadata query result identifies a portion of the contents in the content store.

10. The computer program product of claim 9, wherein the metadata query result is processed by an output representation processor to identify an output representation for the metadata query that is presented to a user.

11. The computer program product of claim 10, wherein the output representation for the metadata query that is presented to the user corresponds to at least one of a graph output, a JSON output, or a text output.

12. The computer program product of claim 10, wherein a LLM is used by the output representation processor to select or configure the output representation for the metadata query.

13. The computer program product of claim 9, wherein a filter is applied to restrict display or querying of data that is not permitted to be accessed by a user that submits the natural language query.

14. The computer program product of claim 9, wherein the natural language query is converted into the query in the metadata query language using a LLM.
computer program product creating a document;
populating metadata for the document;
creating a metadata instance for the document; and
creating an index object in the metadata store for the document.

15. The computer program product of claim 9, further comprising:
fetching a template that corresponds to a document;
transforming the query using a meta template; and
executing a transformed query against the metadata store.

16. A system, comprising:
a processor;
a memory for holding instructions; and
wherein the instructions are executable by the processor for: maintaining, by a content management system, content in a content store and metadata in a metadata store separate from the content store, the metadata in the metadata store corresponding to the content stored in the content store, both the content and the metadata being managed by a content management system, and wherein the set of metadata is generated by a metadata extractor in the content management system that extracts metadata from the content managed by the content management system; receiving, at a metadata query processor of the content management system, a natural language query to search within the content managed by the content management system; converting, by the metadata query processor in the content management system, the natural language query into a metadata query in a metadata query language; and executing, by the content management system, the metadata query in the metadata query language against the metadata store to generate a metadata query result based on at least the metadata extracted from the content managed by the content management system, wherein the metadata query result identifies a portion of the contents in the content store.

17. The system of claim 16, wherein the metadata query result is processed by an output representation processor to identify an output representation for the metadata query that is presented to a user.

18. The system of claim 17, wherein the output representation for the metadata query that is presented to the user corresponds to at least one of a graph output, a JSON output, or a text output.

19. The system of claim 17, wherein a LLM is used by the output representation processor to select or configure the output representation for the metadata query.

20. The system of claim 16, wherein a filter is applied to restrict display or querying of data that is not permitted to be accessed by a user that submits the natural language query.

21. The system of claim 16, wherein the natural language query is converted into the query in the metadata query language using a LLM.

22. The system of claim 16, further comprising:
creating a document;
populating metadata for the document;
creating a metadata instance for the document; and
creating an index object in the metadata store for the document.

23. The system of claim 16, further comprising:
fetching a template that corresponds to a document;
transforming the query using a meta template; and
executing a transformed query against the metadata store.
